(19) United States
(12) Patent Application Publication
(10) Pub. No.: US 2008/0291008 A1
(43) Pub. Date: Nov. 27, 2008

(54) PREVENTIVE TERMINAL DEVICE AND INTERNET SYSTEM FROM DROWSY AND DISTRACTED DRIVING ON MOTORWAYS USING FACIAL RECOGNITION TECHNOLOGY

(76) Inventor: Byong-Hoon JEON, SEOUL (KR)

Correspondence Address: IPLA P.A., 3580 WILSHIRE BLVD., 17TH FLOOR, LOS ANGELES, CA, 90010, US

(21) Appl. No.: 12/021,120

(22) Filed: Jan. 28, 2008

(30) Foreign Application Priority Data
May 22, 2007 (KR) 10-2007-0049724

(51) Int. Cl. H04Q 7/00

(52) U.S. Cl. 340/539.1

(57) ABSTRACT

A drowsy driving prevention apparatus employing a facial recognition technology and a drowsy driving prevention system employing the same is provided. A GPS and a communication unit for informing a central control center or a traffic accident prevention management institute of information about a drowsy driving state and the position of a vehicle are mounted in the drowsy driving prevention apparatus. Thus, traffic accidents can be prevented. A management server is informed of a driver's drowsiness and a driver can access a portable telephone of an external helper over a network using wireless Internet communication technologies, such as Wibro (also called Mobile WiMAX), HSDPA & HSUPA, Long Term Evolution (LTE), Ultra Mobile Broadband (UMB), TD-SCDMA, TRS, GPRS GSM and CDMA. It is therefore possible to prevent traffic accidents caused by drowsy driving in synthetic and multidimensional ways.

### CROSS REFERENCES

Applicant claims foreign priority under Paris Convention and 35 U.S.C. §119 to Korean Patent Application No. 10-2007-0049724, filed May 22, 2007 with the Korean Intellectual Property Office.

### BACKGROUND OF THE INVENTION

1. Field of the Invention

The present invention relates to a drowsy driving prevention apparatus employing a facial recognition technology, in which a Global Positioning System (GPS) and a communication unit are mounted in the apparatus so as to inform a central control center or a traffic accident prevention management institute of information about a drowsy driving state and the position of a vehicle, thus preventing major traffic accidents, and a drowsy driving prevention system employing the same.

2. Background of the Related Art

In general, a drowsy driving alarm apparatus is configured to determine whether a driver of a vehicle is drowsy while driving and, if it is determined that the driver drives a vehicle while dozing off, raise an alarm or drop the window in order to awaken the driver and hence prevent traffic accidents due to drowsy driving. Such a drowsy driving alarm apparatus is generally configured to detect images of a driver's eyes from his or her images input through a camera and determine whether the driver drives a vehicle while dozing off based on the detected eye image.

Korean Patent Registration No. 0617777 discloses “Apparatus and Method for Detecting Driver's Eye Image in Drowsy Driving Warning Apparatus” in which a driver's eye image is detected rapidly from the driver's images input through a camera using an eye monitoring template having a similar structure to that of the driver's eye that was previously stored.

However, the above Koran patent is problematic in that it cannot determine exactly whether a driver drives a vehicle while dozing off because drowsy driving is determined based on the eye image only.

### SUMMARY OF THE INVENTION

Accordingly, the present invention has been made in view of the above problems occurring in the prior art, and it is an object of the present invention to provide a drowsy driving prevention apparatus employing a facial recognition technology, in which a GPS and a communication unit are mounted in the apparatus so as to inform a central control center or a traffic accident prevention management institute of information about a drowsy driving state and the position of a vehicle, thus preventing traffic accidents, and a drowsy driving prevention system employing the same.

It is another object of the present invention to provide a drowsy driving prevention apparatus employing a facial recognition technology, in which it can inform a management server of a driver's drowsiness and gain access to a portable telephone of an external helper over a network using wireless Internet communication technologies, such as Wibro (also called Mobile WiMAX), HSDPA (& HSUPA), Long Term Evolution (LTE), Ultra Mobile Broadband (UMB), TD-SCDMA, TRS, GPRS (GSM) and CDMA, thus preventing traffic accidents caused by drowsy driving in synthetic and multidimensional ways, and a drowsy driving prevention system employing the same.

To achieve the above objects, a drowsy driving prevention apparatus employing a facial recognition technology according to the present invention includes a camera for capturing a driver's face image upon vehicle driving; a user registration unit for storing and managing a face vector template of a driver who is a user of the drowsy driving prevention apparatus; a face image acquisition unit for converting an analog image of the driver's face image captured by the camera into a digital image stream and storing the converted digital image stream in a memory; a face image reader for generating the driver's face vector template based on the digital image stream stored in the memory using the facial recognition technology; a drowsy driving analysis unit for comparing/analyzing the driver's face vector template generated from the face image reader and the driver's stored vector template in order to determine a real driver and a driver's drowsy state; an anti-drowsy driving unit for outputting anti-drowsy contents if the drowsy driving analysis unit determines that the driver's face is a drowsy driving face; and a global positioning system (GPS) for tracking the driver's position.

Furthermore, a drowsy driving prevention system employing a facial recognition technology, the system comprising a drowsy driving prevention apparatus installed within a vehicle and a drowsy driving prevention server communicating with the drowsy driving prevention apparatus wirelessly, wherein the drowsy driving prevention apparatus includes a camera for capturing a driver's face image upon vehicle driving; a user registration unit for storing and managing a face vector template of a driver who is a user of the drowsy driving prevention apparatus; a face image acquisition unit for converting an analog image of the driver's face image captured by the camera into a digital image stream and storing the converted digital image stream in a memory; a face image reader for generating the driver's face vector template based on the digital image stream stored in the memory using the facial recognition technology; a drowsy driving analysis unit for comparing/analyzing the driver's face vector template generated from the face image reader and the driver's stored vector template in order to determine a real driver and a driver's drowsy state; an anti-drowsy driving unit for outputting anti-drowsy contents if the drowsy driving analysis unit determines that the driver's face is a drowsy driving face; a GPS for tracking the driver's position; and a communication unit for transmitting information about a drowsy driving state, including image information, to the outside and receiving corresponding information for eliminating drowsy driving from the outside, if the drowsy driving analysis unit determines that the driver's face is a drowsy driving face, and wherein the drowsy driving prevention server includes a member registration unit for registering therein a driver who will be provided with various anti-drowsy driving services over a wireless Internet as a member, storing the member's face vector template at normal times, and using the member's face vector template as an authentication key; an anti-drowsy contents management unit for storing and managing anti-drowsy contents for preventing drowsy driving; a face authentication unit for comparing a member's first face vector template received from the drowsy driving prevention apparatus and the registered face vector template in order to determine whether the member is a service member; a drowsy driving determination unit for analyzing a vector template from the member's real-time face image received from the drowsy driving prevention apparatus and continuously comparing/analyzing the member's real-time face image and the member's stored vector template in order to determine the driver's drowsy state; an anti-drowsy service unit for providing the anti-drowsy contents to the drowsy driving prevention apparatus if the drowsy driving determination unit determines that the driver is in a drowsy driving state; and a communication unit for transmitting and receiving various data while communicating with the drowsy driving prevention apparatus using wired/wireless communication methods.

### BRIEF DESCRIPTION OF THE DRAWINGS

Further objects and advantages of the invention can be more fully understood from the following detailed description taken in conjunction with the accompanying drawings in which:

FIG. 1 is a schematic view of a drowsy driving prevention system employing a facial recognition technology according to the present invention;

FIG. 2 is a block diagram of the drowsy driving prevention apparatus according to the present invention;

FIG. 3 is a block diagram of a drowsy driving prevention server according to the present invention; and

FIG. 4 is a flowchart illustrating a method of preventing drowsy driving employing a facial recognition technology according to the present invention.

### DETAILED DESCRIPTION OF THE PREFERRED EMBODIMENT

A drowsy driving prevention apparatus employing a facial recognition technology and a drowsy driving prevention system employing the same according to the present invention will now be described in detail with reference to the accompanying drawings.

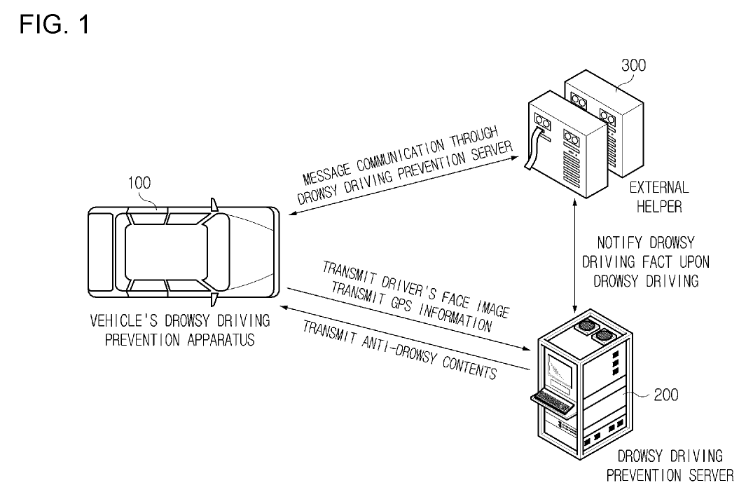

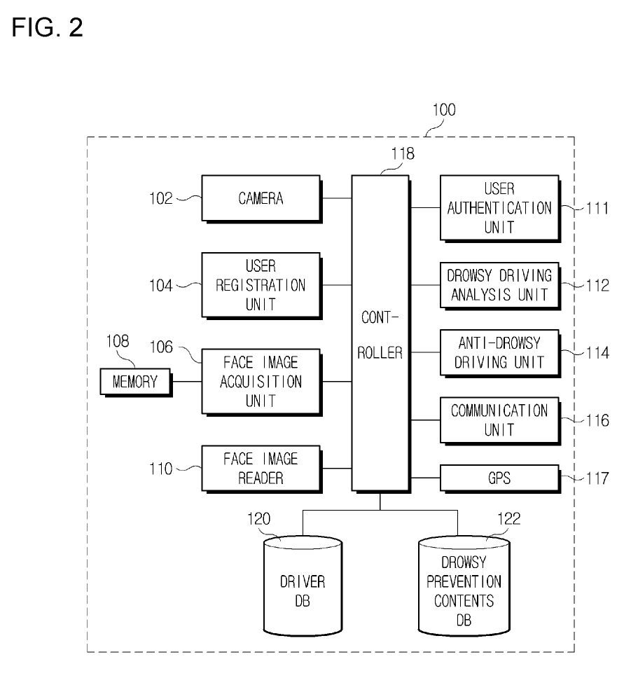

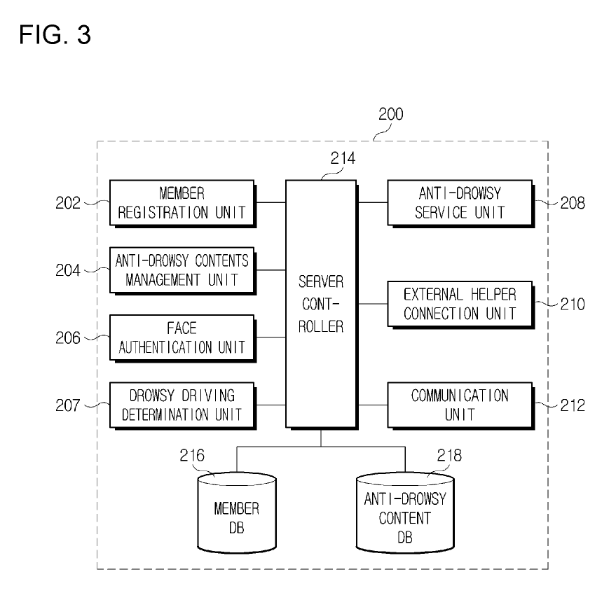

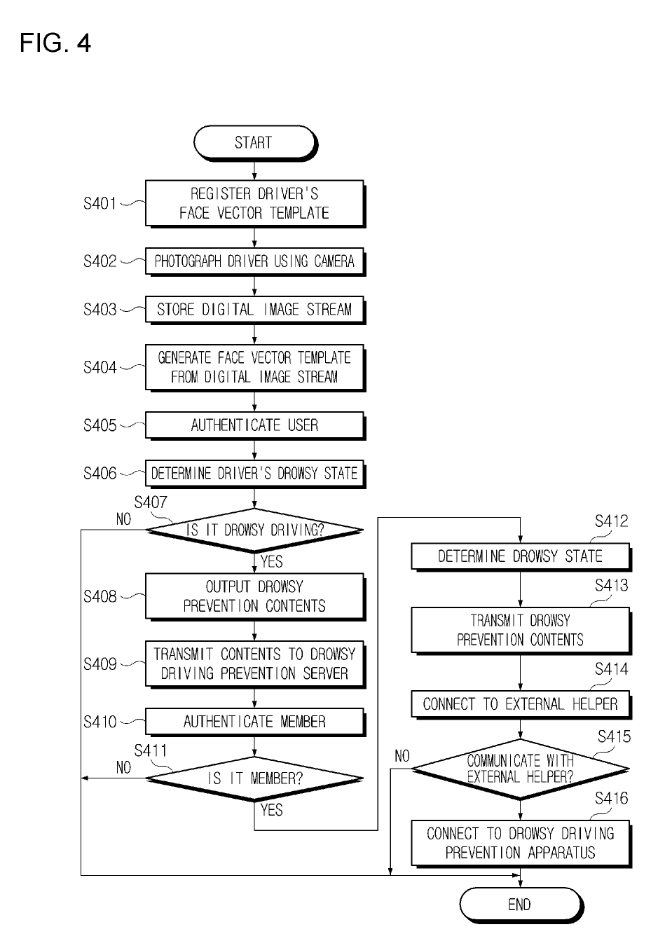

FIG. 1 is a schematic view of a drowsy driving prevention system employing a facial recognition technology according to the present invention. FIG. 2 is a block diagram of the drowsy driving prevention apparatus according to the present invention. FIG. 3 is a block diagram of a drowsy driving prevention server according to the present invention. FIG. 4 is a flowchart illustrating a method of preventing drowsy driving employing a facial recognition technology according to the present invention.

Referring to FIG. 1, according to the present invention, a driver's face vector template is generated using the driver's face images captured by a camera of the drowsy driving prevention apparatus while driving and then compared with the driver's vector template, which has been registered at normal times in order to determine whether the driver drives a vehicle while dozing off. If, as a result of the comparison, it is determined that the driver dozes off, various warning methods for preventing drowsy driving are executed. The driver's drowsy looks are sent to a drowsy driving prevention server, which then executes anti-drowsy driving contents, and are also sent to an external helper.

Referring to FIG. 2, a drowsy driving prevention apparatus 100 includes a camera 102, a user registration unit 104, a face image acquisition unit 106, a face image reader 110, a user authentication unit 111, a drowsy driving analysis unit 112, an anti-drowsy driving unit 114, a communication unit 116, and a controller 118.

The camera 102 functions to photograph a driver's face while driving.

The user registration unit 104 stores a vector template of a driver's face (who is the user of the drowsy driving prevention apparatus 100) in a driver DB 120. The driver's face vector template refers to a value in which all characteristic elements constituting the driver's face are extracted and quantified and is used to calculate and analyze the eye's flickering, the face angle, shaking, etc. for recognizing drowsy driving.

The face image acquisition unit 106 functions to convert an analog image of a driver's face image captured by the camera 102 into a digital image stream and store the digital image stream in memory 108. In the event that the camera 102 is disposed outside the drowsy driving prevention apparatus 100, a captured face image can be received through wired/wireless communications.

The face image reader 110 generates the driver's first face vector template based on the digital image stream stored in the memory 108 using a facial recognition technology. At this time, when the driver's face vector template is not generated based on the driver's face image captured by the camera 102, the driver's face image captured by the camera 102 is determined not to be a face image or an input image is determined to be error of image acquisition due to the camera that is not controlled and noncooperation of the driver and a corresponding error message is displayed in order to call the driver's attention.

The user authentication unit 111 authenticates an authentic driver by comparing/analyzing the driver's first face vector template generated from the face image reader 110 and the driver's vector template stored in the driver DB 120. If, as a result of the comparison/analysis, it is determined the driver's first face vector template generated from the face image reader 110 is not identical to the driver's vector template stored in the driver DB 120, the driver may not drive a car.

The drowsy driving analysis unit 112 continuously compares/analyzes the driver's first face vector template generated from the face image reader 110 and the driver's vector template stored in the driver DB 120 in order to confirm the driver's drowsy state. For example, the drowsy driving analysis unit 112 can track and monitor the driver's drowsy driving by continuously comparing the vector template of the captured face image, such as the eye's flickering, a face angle, and shaking, and its previous state and the stored vector template using a facial recognition technology and a statistic process.

If the driver's face is determined as a drowsy driving face in the drowsy driving analysis unit 112, the anti-drowsy driving unit 114 outputs drowsy driving warning radio waves and anti-drowsy contents, such as multimedia digital images, sound, texts, and text-to-speech, which are stored in a drowsy prevention contents DB 122. The drowsy driving warning radio waves and the anti-drowsy contents can be output through a vehicle's display or speaker.

The communication unit 116 transmits the driver's first face vector template generated from the face image reader 110 and the image of the drowsy driver determined in the drowsy driving analysis unit 112 to a drowsy driving prevention server 200 through a wireless Internet communication gateway of the communication unit 116 having communication functions such as Wibro (called Mobile WiMax), HSDPA (& HSUPA), LTE (Long Term Evolution), UMB (Ultra Mobile Broadband), TD-SCDMA, TRS, GPRS (GSM) and CDMA.

The GPS 117 is mounted in the drowsy driving prevention apparatus 100 and functions to track a driver's position. The position tracked by the GPS is sent to the drowsy driving prevention server 200.

The controller 118 controls the data flow in the drowsy driving prevention apparatus 100.

Referring to FIG. 3, the drowsy driving prevention server 200 includes a member registration unit 202, an anti-drowsy contents management unit 204, a face authentication unit 206, a drowsy driving determination unit 207, an anti-drowsy service unit 208, an external helper connection unit 210, a communication unit 212 and a server controller 214.

The member registration unit 202 registers therein a driver who will receive various drowsy driving prevention services over a wireless Internet as a member. The member registration unit 202 also stores a face vector template of a member at normal times in a member DB 216 and uses the face vector template as an authentication key. Further, the member registration unit 202 receives information about external helpers, such as families, relatives, close acquaintances, a traffic administration institute, and traffic police to which a driver's drowsy driving situation will be sent when the driver drives while dozing off, and stores the information in the member DB 216.

The anti-drowsy contents management unit 204 stores contents for preventing drowsy driving, such as digital images, sound, texts, and text-to-speech, in an anti-drowsy content DB 218. The contents stored in the anti-drowsy content DB 218 can be provided to the drowsy driving prevention apparatus 100 for updating purpose.

The face authentication unit 206 determines whether a driver is a service member by comparing/analyzing the member's face vector template, received from the drowsy driving prevention apparatus 100, and the face vector template registered with the member DB 216. If it is determined that the driver is a service member, the face authentication unit 206 compares the driver's face vector template received in real-time and the driver's vector template stored in the driver DB 120 in order to determine whether the driver drives a car while dozing off. At this time, if it is determined that the driver is not a service member, the face authentication unit 206 sends a not allowed access notice to the drowsy driving prevention apparatus 100.

The drowsy driving determination unit 207 analyzes a vector template of a member's real-time face image received from the drowsy driving prevention apparatus 100, and continuously compares/analyzes the member's real-time vector template and the member's stored vector template in order to determine the driver's drowsy state.

If the member's driving state is determined to be drowsy driving in the drowsy driving determination unit 207, the anti-drowsy service unit 208 sends contents, such as digital images, sound, texts, and text-to-speech stored in the anti-drowsy content DB 208, to the drowsy driving prevention apparatus 100.

The external helper connection unit 210 provides the drowsy driving image, received from the drowsy driving prevention apparatus, to a contact number of an external helper 300 registered with the member DB 216, and sends the contact number of the external helper 300 to the drowsy driving prevention apparatus 100 so that the driver can communicate with the external helper 300.

The communication unit 212 transmits/receives various data while communicating with the drowsy driving prevention apparatus 100 and the external helper 300 using wired/wireless communication methods.

The server controller 214 controls a data flow in the drowsy driving prevention server 200.

Hereinafter, the present invention is described in detail with reference to the flowchart.

A user of the drowsy driving prevention apparatus 100 registers a driver's face vector template, which is extracted from the driver's face photographed by a camera, as a vehicle's driver and stores the driver's face vector template in the driver DB 120 (step S401).

The vehicle's camera 102 captures an image of a driver's face and sends the captured image information to the drowsy driving prevention apparatus 100 (step S402). The face image acquisition unit 106 of the drowsy driving prevention apparatus digitalizes the image information, converts the digital image information into a digital image stream, and stores the converted digital image stream in the memory 108 (step S403). At this time, the memory 108 may include cyclic memory in which information is refreshed periodically.

The face image reader 110 generates a small-sized vector template based on the digital image stream stored in the memory 108 using a face recognition algorithm for recognizing characteristics unique to a driver's face (step S404). At this time, when the driver's face vector template is not generated based on the driver's face image captured by the camera, the driver's face image captured by the camera is determined not to be a face image or an input image is determined to be error of image acquisition due to the camera that is not controlled and noncooperation of the driver and a corresponding error message is displayed in order to call the driver's attention.

After the driver's first vector template is generated, the user authentication unit 111 compares/analyzes the driver's first vector template generated in the face image reader 110 and the driver's vector template stored in the driver DB 120 in order to determine whether the driver is an authentic driver (step S405). At this time, if it is determined the driver's first face vector template generated from the face image reader 110 is not identical to the driver's vector template stored in the driver DB 120, the driver may not drive a car.

If it is determined that the driver is an authentic driver, the drowsy driving analysis unit 112 continuously compares/analyzes the driver's first face vector template generated from the face image reader 110 and the driver's vector template stored in the driver DB 120 in order to determine the driver's drowsy state (step S406). That is, the drowsy driving analysis unit 112 can track and monitor the driver's drowsy driving by continuously comparing the vector template, such as the eye's flickering, a face angle, and shaking, and its previous state based on the digital image stream using a facial recognition technology.

If, as a result of the determination, the driver's drowsy driving is determined in the drowsy driving analysis unit 112 (step S407), the anti-drowsy driving unit 114 outputs contents, such as digital images and sound for anti-drowsiness, which are stored in the drowsy prevention contents DB 122, as an alarm message or alarm sound in order to call the driver's attention (step S408). The drowsy driving warning radio waves and the anti-drowsy contents can be output through a vehicle's display or speaker.

If it is determined that the driver's face image belongs to drowsy driving in the drowsy driving analysis unit 112, the image of the drowsy driver is transmitted to the drowsy driving prevention server 200 through a wireless Internet communication gateway of the communication unit 116 having communication functions such as Wibro, HSDPA & HSUPA, LTE, UMB, TD-SCDMA, TRS, GPRS (GSM) and CDMA (step S409). At this time, an encrypted face recognition vector template that is previously generated is also sent along with the driver's drowsy driving image information in order to authenticate a user.

The face authentication unit 112 of the drowsy driving prevention server 200 determines whether the driver is a service member by comparing the driver's first face recognition vector template received from the drowsy driving prevention apparatus 206 and the member's vector template stored in the member DB 216 (step S410). If, as a result of the determination, the driver is not a service member, a not allowed access notice is sent to the drowsy driving prevention apparatus 100.

If, as a result of the determination, the driver is a service member (step S411), the drowsy driving determination unit 207 analyzes the vector template based on the member's real-time face image received from the drowsy driving prevention apparatus 100 and compares/analyzes the member's real-time face image and the vector template stored in the member DB 216 in order to determine the driver's drowsy state (step S412).

The anti-drowsy service unit 208 transmits contents, such as digital images, sound, texts, and text-to-speech which are stored in the anti-drowsy content DB 218, to the drowsy driving prevention apparatus 100 (step S413).

Further, the member's drowsy driving image received from the drowsy driving prevention apparatus is provided to a contact number of the external helper 300, which has been registered with the member DB 216, through the external helper connection unit 210 (step S414). If the contact number of the external helper 300 is connected (step S415), the member's drowsy driving image is sent to the drowsy driving prevention apparatus 100 so that the driver can communicate with the external helper 300 in real-time (step S415).

Meanwhile, the drowsy driving prevention server 100 can confirm the driver's position through the GPS 117 attached to the drowsy driving prevention apparatus 100. If the driver continues driving while dozing off, the drowsy driving prevention server 100 can inform a traffic accident prevention management institute, etc., which is the external helper 300, of this fact, thus preventing traffic accidents.

As described above, a driver's drowsy driving state within a vehicle that is driven at high speed can be recognized continuously using a facial recognition technology-based drowsy driving analysis technique. Accordingly, drowsy driving can be prevented.

Further, a driver's drowsiness is provided to the management server and a driver can gain access to an external helper using a portable telephone over a network using wireless Internet communication technologies such as Wibro, HSDPA & HSUPA, LTE, UMB, TD-SCDMA, TRS, GPRS GSM or CDMA. Accordingly, traffic accidents by drowsy driving can be prevented in synthetic and multidimensional ways.

Further, a driver's current driving position can be tracked using a GPS according to an instruction of a drowsy driving prevention server depending on the degree of the driver's drowsy driving and is informed to a traffic accident prevention management institute, etc. Accordingly, traffic accidents due to drowsiness can be prevented.

Further, images within a vehicle and a driver's drowsy driving state are automatically informed to external helpers such as families and close acquaintances through a text message or MMS (multi-media message), voice messages, mobile phone and various wireless Internet terminals. Thus, drowsy driving can be eliminated remotely through a call with an external helper.

Further, an external drowsy driving prevention server continuously provides strong and live contents for drowsy prevention in real-time while communicating with the drowsy driving prevention apparatus mounted in a vehicle. Accordingly, drowsy driving preventing and elimination effects can be maximized.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A drowsy driving prevention apparatus employing a facial recognition technology, the apparatus comprising:
a camera for capturing a driver's face image upon vehicle driving;
a user registration unit for storing and managing a face vector template of a driver who is a user of the drowsy driving prevention apparatus;
a face image acquisition unit for converting an analog image of the driver's face image captured by the camera into a digital image stream and storing the converted digital image stream in a memory;
a face image reader for generating the driver's face vector template based on the digital image stream stored in the memory using the facial recognition technology;
a drowsy driving analysis unit for comparing/analyzing the driver's face vector template generated from the face image reader and the driver's stored vector template in order to determine a real driver and a driver's drowsy state;
an anti-drowsy driving unit for outputting anti-drowsy contents if the drowsy driving analysis unit determines that the driver's face is a drowsy driving face; and
a global positioning system (GPS) for tracking the driver's position.

2. A drowsy driving prevention apparatus employing a facial recognition technology, the apparatus comprising:
a camera for capturing a driver's face image upon vehicle driving;
a user registration unit for storing and managing a face vector template of a driver who is a user of the drowsy driving prevention apparatus;
a face image acquisition unit for converting an analog image of the driver's face image captured by the camera into a digital image stream and storing the converted digital image stream in a memory;
a face image reader for generating the driver's face vector template based on the digital image stream stored in the memory using the facial recognition technology;
a drowsy driving analysis unit for comparing/analyzing the driver's face vector template generated from the face image reader and the driver's stored vector template in order to determine a real driver and a driver's drowsy state;
an anti-drowsy driving unit for outputting anti-drowsy contents if the drowsy driving analysis unit determines that the driver's face is a drowsy driving face; and
a communication unit for transmitting information about a drowsy driving state, including image information, to the outside and receiving corresponding information for eliminating drowsy driving from the outside, if the drowsy driving analysis unit determines that the driver's face is a drowsy driving face.

3. A drowsy driving prevention system employing a facial recognition technology, the system comprising a drowsy driving prevention apparatus installed within a vehicle and a drowsy driving prevention server communicating with the drowsy driving prevention apparatus wirelessly,
wherein the drowsy driving prevention apparatus comprises:
a camera for capturing a driver's face image upon vehicle driving;
a user registration unit for storing and managing a face vector template of a driver who is a user of the drowsy driving prevention apparatus;
a face image acquisition unit for converting an analog image of the driver's face image captured by the camera into a digital image stream and storing the converted digital image stream in a memory;
a face image reader for generating the driver's face vector template based on the digital image stream stored in the memory using the facial recognition technology;
a drowsy driving analysis unit for comparing/analyzing the driver's face vector template generated from the face image reader and the driver's stored vector template in order to determine a real driver and a driver's drowsy state;
an anti-drowsy driving unit for outputting anti-drowsy contents if the drowsy driving analysis unit determines that the driver's face is a drowsy driving face;
a GPS for tracking the driver's position; and
a communication unit for transmitting information about a drowsy driving state, including image information, to the outside and receiving corresponding information for eliminating drowsy driving from the outside, if the drowsy driving analysis unit determines that the driver's face is a drowsy driving face, and
wherein the drowsy driving prevention server comprises:
a member registration unit for registering therein a driver who will be provided with various anti-drowsy driving services over a wireless Internet as a member, storing the member's face vector template at normal times, and using the member's face vector template as an authentication key;
an anti-drowsy contents management unit for storing and managing anti-drowsy contents for preventing drowsy driving;
a face authentication unit for comparing a member's first face vector template received from the drowsy driving prevention apparatus and the registered face vector template in order to determine whether the member is a service member;
a drowsy driving determination unit for analyzing a vector template from the member's real-time face image received from the drowsy driving prevention apparatus and continuously comparing/analyzing the member's real-time face image and the member's stored vector template in order to determine the driver's drowsy state;
an anti-drowsy service unit for providing the anti-drowsy contents to the drowsy driving prevention apparatus if the drowsy driving determination unit determines that the driver is in a drowsy driving state; and
a communication unit for transmitting and receiving various data while communicating with the drowsy driving prevention apparatus using wired/wireless communication methods.

4. The drowsy driving prevention system of claim 3, further comprising an external helper connection unit for providing the image of the drowsy driving driver, which is received from the drowsy driving prevention apparatus, to a contact number of an external helper and transmitting the contact number of the external helper to the drowsy driving prevention apparatus so that the driver can communicate with the external helper in real-time.

5. The drowsy driving prevention system of claim 3, wherein the external helper includes one of families, close acquaintances, friends, a traffic administration institute, and traffic police.

6. A method of preventing drowsy driving employing a typical facial recognition technology, the method comprising the steps of:
registering a driver's face vector template, which is extracted from a driver's face, as a vehicle's driver in a drowsy driving prevention apparatus installed within the vehicle;
converting a driver's face captured by a camera into a digital image stream and storing the converted digital image stream in a memory;
generating a small-sized vector template based on the digital image stream stored in the memory using a face recognition algorithm for recognizing characteristics unique to the driver's face;
comparing the driver's generated first face vector template and the small-sized vector template in order to authenticate the driver;
comparing the driver's captured face vector template and the driver's stored vector template in order to determine the driver's drowsy state;
if it is determined that the driver is in a drowsy driving state, outputting anti-drowsy contents;
transmitting the driver's first face vector template and an image of a drowsy driver that is captured in real-time to a drowsy driving prevention server through wireless communication;
allowing the drowsy driving prevention server to compare the driver's face recognition vector template received from the drowsy driving prevention apparatus and a member's vector template stored in the drowsy driving prevention server in order to determine whether the driver is a service member;
analyzing a vector template from the member's real-time face image and comparing/comparing the member's real-time vector template and the stored vector template in order to determine the driver's drowsy state; and
if the registered drowsy driving is determined, transmitting anti-drowsy contents stored in the drowsy driving prevention server to the drowsy driving prevention apparatus.

7. The method of claim 6, further comprising the steps of:
allowing the drowsy driving prevention server to provide the member's drowsy driving image to a contact number of a registered external helper; and
if a communication with the external helper is successful, transmitting the communication to the drowsy driving prevention apparatus so that the driver can communicate with the external helper in real-time.

8. The method of claim 6, further comprising the steps of:
allowing the drowsy driving prevention apparatus to provide a GPS position to the drowsy driving prevention server along with the driver's face image; and
allowing the drowsy driving prevention server to notify the external helper of the GPS position.
